(19) United States
(12) Patent Application Publication
(10) Pub. No.: US 2024/0419944 A1
(43) Pub. Date: Dec. 19, 2024

(54) SAMPLING OPERATIONS IN A COMPUTER VISION TOOL TO REGULATE DOWNSTREAM TASKS

(71) Applicant: Microsoft Technology Licensing, LLC, Redmond, WA (US)

(72) Inventors: Oron NIR, Herzeliya (IL); Fardau VAN NEERDEN, Driel (NL); Inbal SAGIV, Kfar Saba (IL)

(73) Assignee: Microsoft Technology Licensing, LLC, Redmond, WA (US)

(21) Appl. No.: 18/209,421

(22) Filed: Jun. 13, 2023

(51) Int. Cl. G06N 3/0455; G06N 3/0464

(52) U.S. Cl. CPC G06N 3/0455; G06N 3/0464

(57) ABSTRACT

Sampling operations enable a computer vision tool to regulate downstream tasks. The sampling operations can indicate which frames of a video sequence should be processed by different downstream tasks. For example, a computer vision tool receives encoded data for a given frame and uses the encoded data to determine inputs for machine learning models in different channels. The computer vision tool provides the inputs to the machine learning models, respectively, and fuses results from the machine learning models. In this way, the computer vision tool determines a set of event indicators for the given frame. Based at least in part on the event indicator(s) for the given frame, the computer vision tool regulates downstream tasks for the given frame (e.g., selectively performing or skipping downstream tasks for the given frame, or otherwise adjusting how and when downstream tasks are performed for the given frame).

### BACKGROUND

In a computer system, a computer vision tool can be used to gain insights about content in an image or video sequence. For example, a computer vision tool can run an object detection task to detect or recognize objects in frames of video, and the computer vision tool can run an object tracking task to track the movements of objects in frames of video. Typically, a specific object detection task or object tracking task is trained (that is, adapted or configured based on representative input data) to detect or recognize or track a specific type of object in a video sequence, such as faces, persons, cars or other vehicles, logos, plants, animals, foods, or text or other characters. As another example, a computer vision tool can run an action recognition task to recognize certain types of actions. Typically, a specific action recognition task is trained to recognize a specific type of action. The results of tasks to detect, recognize, or track objects or actions can be used for other purposes in the computer vision tool, such as building an index for a video sequence or creating links to appearances of objects in a video sequence.

Object detection or recognition, object tracking, action recognition and other tasks in a computer vision tool are often expensive in terms of processor utilization and memory utilization. As noted above, tasks may be trained for a particular type of object or action. Sometimes, tasks are further trained for a particular type of video source or video quality level such as video from a surveillance camera. To detect, recognize, or track a wide variety of objects and actions, in video from various video sources and with different video quality levels, a computer vision tool may need to run a large number of tasks on a given frame of video. When the computer vision tool repeats such tasks for 10, 15, 30, or more frames of video per second, the overall cost of running the tasks can be very high in terms of resource utilization.

### SUMMARY

In summary, the detailed description presents innovations in sampling operations in a computer vision tool to regulate downstream tasks. The sampling operations can indicate which frames of a video sequence should be processed by different downstream tasks. Using results of the sampling operations, the computer vision tool can selectively perform or skip downstream tasks for different frames of a video sequence, or otherwise adjust how and when downstream tasks are performed for the different frames of the video sequence. In this way, the computer vision tool can reduce the overall computational cost of operations for the downstream tasks by avoiding performance of downstream tasks that are unlikely to produce useful results. In some example implementations, the sampling operations themselves are performed in a “lightweight” way without incurring significant delay or computational overhead in the computer vision tool.

According to a first aspect of techniques and tools described herein, a computer vision tool receives encoded data for a given frame of a video sequence. The computer vision tool determines inputs for machine learning models in different channels using the encoded data.

In some example implementations, when determining the inputs using the encoded data, the computer vision tool decodes only a subset of the frames (less than all of the frames) of the video sequence, which reduces resource utilization to determine the inputs (compared to an approach in which all frames are decoded). For example, the inputs for the given frame are part of three time series-a time series of reconstructed frames, a time series of motion information, and a time series of residual information. If the given frame is intra-coded, the computer vision tool decodes encoded data for the given frame to produce a reconstructed version of the given frame. The reconstructed version of the given frame is part of the time series of reconstructed frames. On the other hand, if the given frame is not intra-coded, the computer vision tool selects, from the time series of reconstructed frames, a reconstructed version of a previous frame to use for the given frame. The computer vision tool also determines motion information for the given frame based at least in part on motion vector values decoded or derived from the encoded data and determines residual information for the given frame based at least in part on residual values decoded or derived from the encoded data.

The computer vision tool determines a set of one or more event indicators for the given frame. For example, an event indicator for the given frame is a single classification for the given frame, where different downstream tasks have been trained for different types of classification. Or, as another example, event indicators for the given frame are scores for multiple types of events, where different downstream tasks have been trained for different types of events. The types of events can be types of objects or actions.

In particular, to determine the event indicator(s) for the given frame, the computer vision tool provides the inputs to the machine learning models, respectively, which have been trained to identify events in different types of inputs. Depending on implementation, a machine learning model can use a two-dimensional convolutional neural network (“CNN”), three-dimensional CNN, a video transformer, or a temporal dilated video transformer. The computer vision tool fuses results from the machine learning models. The computer vision tool can use a cross-attention layer to fuse the results from the machine learning models.

Based at least in part on the event indicator(s) for the given frame, the computer vision tool regulates downstream tasks for the given frame. For example, the computer vision tool selects which downstream tasks, if any, to use for the given frame. For a given downstream task, the computer vision tool can selectively perform, or cause to be performed, the given downstream task for the given frame, if the given downstream task is to be used for the given frame. Or, the computer vision tool can selectively skip, or cause to be skipped, the given downstream task for the given frame, if the given downstream task is not to be used for the given frame. Or, as another example, the computer vision tool can adjust one or more of the downstream tasks for the given frame. In this way, the computer vision tool can reduce overall resource utilization by the downstream tasks.

The downstream tasks depend on implementation and can, for example, include a text or character recognition task, a face detection task, a person detection task, a vehicle detection task, an object detection task for another type of object, a face tracking task, a person tracking task, a vehicle tracking task, an object tracking task for another type of object, and/or an action recognition task. The downstream tasks can be implemented in the computer vision tool or implemented separately, e.g., in a different computer system connected over a network to the computer vision tool.

The innovations described herein can be implemented as part of a method, as part of a computer system (physical or virtual, as described below) configured to perform the method, or as part of a tangible computer-readable media storing computer-executable instructions for causing one or more processors, when programmed thereby, to perform the method. The various innovations can be used in combination or separately. The innovations described herein include the innovations covered by the claims. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

### BRIEF DESCRIPTION OF THE DRAWINGS

The following drawings illustrate some features of the disclosed innovations.

FIG. 1 is a diagram illustrating an example computer system in which some described embodiments can be implemented.

FIGS. 2a and 2b are diagrams of example computer vision tools in which some described embodiments can be implemented.

FIG. 3 is a diagram of an example processing flow for sampling operations in a computer vision tool to regulate downstream tasks.

FIGS. 4a and 4b are diagrams of example machine learning models usable in sampling operations in a computer vision tool.

FIG. 5a is a flowchart illustrating a generalized technique for sampling operations in a computer vision tool to regulate downstream tasks. FIGS. 5b and 5c are flowcharts illustrating example operations for two of the operations, respectively, in FIG. 5a.

### DETAILED DESCRIPTION

The detailed description presents innovations in sampling operations in a computer vision tool to regulate downstream tasks. For example, a computer vision tool receives encoded data for a given frame of a video sequence and uses the encoded data to determine inputs for machine learning models in different channels. The computer vision tool provides the inputs to the machine learning models, respectively, and fuses results from the machine learning models. In this way, the computer vision tool determines a set of one or more event indicators for the given frame. Based at least in part on the event indicator(s) for the given frame, the computer vision tool regulates downstream tasks for the given frame.

In typical usage scenarios, the sampling operations indicate which frames of a video sequence should be processed by different downstream tasks. Using results of the sampling operations, the computer vision tool can selectively perform or skip downstream tasks for different frames of a video sequence, or otherwise adjust how and when downstream tasks are performed for the different frames of the video sequence. In this way, the computer vision tool can reduce the overall cost of operations for the downstream tasks by avoiding performance of downstream tasks that are unlikely to produce useful results. In some example implementations, the sampling operations themselves are performed in a “lightweight” way without incurring significant delay or overhead in the computer vision tool.

As used herein, the term “computer vision tool” indicates any computer-implemented tool configured to perform sampling operations to regulate downstream tasks. The downstream tasks can include, for example, a text or character recognition task, a face detection task, a person detection task, a vehicle detection task, an object detection task for another type of object, a face tracking task, a person tracking task, a vehicle tracking task, an object tracking task for another type of object, an action recognition task, and/or another computer vision task. Some or all of the downstream tasks can be implemented in a separate computer system, e.g., connected over a network to the computer vision tool. A computer vision tool can, for example, be a video indexing tool, video classification tool, video analysis tool, object detection or recognition tool, object tracking tool, action recognition tool, image segmentation tool, image classification tool, or feature extraction tool.

In the examples described herein, identical reference numbers in different figures indicate an identical component, module, or operation. More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique or tool does not solve all such problems. Many of the innovations described herein provide one or more of the technical advantages described herein, but a given technique or tool need not provide all such advantages. It is to be understood that other examples may be utilized and that structural, logical, software, hardware, and electrical changes may be made without departing from the scope of the disclosure. The following description is, therefore, not to be taken in a limited sense.

### I. Example Computer Systems

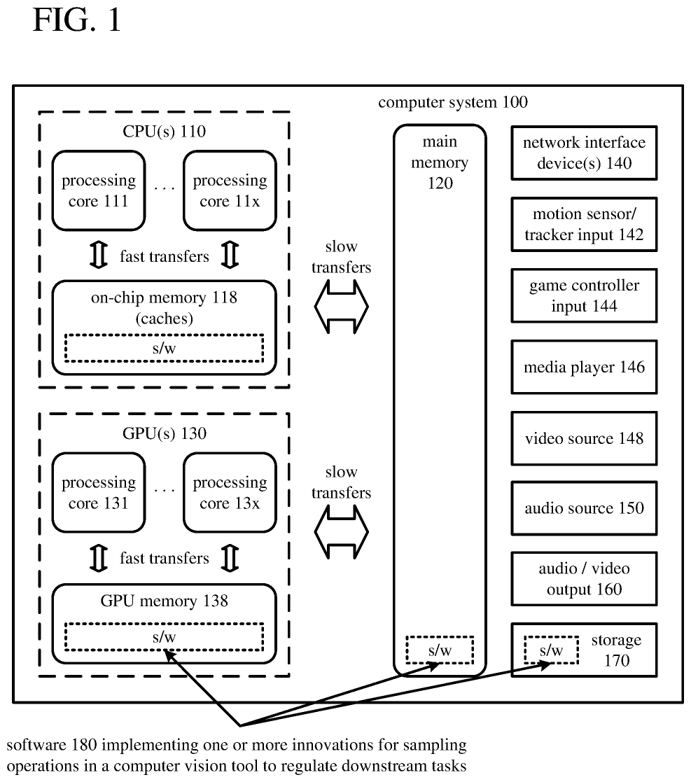

FIG. 1 illustrates a generalized example of a suitable computer system (100) in which several of the described innovations may be implemented. The innovations described herein relate to sampling operations in a computer vision tool to regulate downstream tasks. The computer system (100) is not intended to suggest any limitation as to scope of use or functionality, as the innovations may be implemented in diverse computer systems, including special-purpose computer systems.

With reference to FIG. 1, the computer system (100) includes one or more processing cores (110 . . . 11x) and local memory (118) of a central processing unit (“CPU”) or multiple CPUs. The processing core(s) (110 . . . 11x) are, for example, processing cores on a single chip, and execute computer-executable instructions. The number of processing core(s) (110 . . . 11x) depends on implementation and can be, for example, 4 or 8. The local memory (118) may be volatile memory (e.g., registers, cache, random access memory (“RAM”)), non-volatile memory (e.g., read-only memory (“ROM”), electrically-erasable programmable ROM (“EEPROM”), flash memory), or some combination of the two, accessible by the respective processing core(s) (110 . . . 11x). Alternatively, the processing cores (110 . . . 11x) can be part of a system-on-a-chip (“SoC”), application-specific integrated circuit (“ASIC”), or other integrated circuit.

The local memory (118) can store software (180) implementing aspects of the innovations for sampling operations in a computer vision tool to regulate downstream tasks, for operations performed by the respective processing core(s) (110 . . . 11x), in the form of computer-executable instructions. In FIG. 1, the local memory (118) is on-chip memory such as one or more caches, for which access operations, transfer operations, etc. with the processing core(s) (110 . . . 11x) are fast.

The computer system (100) also includes processing cores (130 . . . 13x) and local memory (138) of a graphics processing unit (“GPU”) or multiple GPUs. The number of processing cores (130 . . . 13x) of the GPU depends on implementation. The processing cores (130 . . . 13x) are, for example, part of single-instruction, multiple data (“SIMD”) units of the GPU. The SIMD width n, which depends on implementation, indicates the number of elements (sometimes called lanes) of a SIMD unit. For example, the number of elements (lanes) of a SIMD unit can be 16, 32, 64, or 128 for an extra-wide SIMD architecture. The GPU memory (138) may be volatile memory (e.g., registers, cache, RAM), non-volatile memory (e.g., ROM, EEPROM, flash memory), or some combination of the two, accessible by the respective processing cores (130 . . . 13x). The GPU memory (138) can store software (180) implementing aspects of the innovations for sampling operations in a computer vision tool to regulate downstream tasks, for operations performed by the respective processing cores (130 . . . 13x), in the form of computer-executable instructions such as shader code.

The computer system (100) includes main memory (120), which may be volatile memory (e.g., RAM), non-volatile memory (e.g., ROM, EEPROM, flash memory), or some combination of the two, accessible by the processing core(s) (110 . . . 11x, 130 . . . 13x). The main memory (120) stores software (180) implementing aspects of the innovations for sampling operations in a computer vision tool to regulate downstream tasks, in the form of computer-executable instructions. In FIG. 1, the main memory (120) is off-chip memory, for which access operations, transfer operations, etc. with the processing cores (110 . . . 11x, 130 . . . 13x) are slower.

More generally, the term “processor” refers generically to any device that can process computer-executable instructions and may include a microprocessor, microcontroller, programmable logic device, digital signal processor, and/or other computational device. A processor may be a processing core of a CPU, other general-purpose unit, or GPU. A processor may also be a specific-purpose processor implemented using, for example, an ASIC or a field-programmable gate array (“FPGA”). A “processing system” is a set of one or more processors, which can be located together or distributed across a network.

The term “control logic” refers to a controller or, more generally, one or more processors, operable to process computer-executable instructions, determine outcomes, and generate outputs. Depending on implementation, control logic can be implemented by software executable on a CPU, by software controlling special-purpose hardware (e.g., a GPU or other graphics hardware), or by special-purpose hardware (e.g., in an ASIC).

The computer system (100) includes one or more network interface devices (140). The network interface device(s) (140) enable communication over a network to another computing entity (e.g., server, other computer system). The network interface device(s) (140) can support wired connections and/or wireless connections, for a wide-area network, local-area network, personal-area network or other network. For example, the network interface device(s) can include one or more Wi-Fi® transceivers, an Ethernet® port, a cellular transceiver and/or another type of network interface device, along with associated drivers, software, etc. The network interface device(s) (140) convey information such as computer-executable instructions, audio or video input or output, or other data in a modulated data signal over network connection(s). A modulated data signal is a signal that has one or more of its characteristics set or changed in such a manner as to encode information in the signal. By way of example, the network connections can use an electrical, optical, RF, or other carrier.

The computer system (100) optionally includes a motion sensor/tracker input (142) for a motion sensor/tracker, which can track the movements of a user and objects around the user. For example, the motion sensor/tracker allows a user (e.g., player of a game) to interact with the computer system (100) through a natural user interface using gestures and spoken commands. The motion sensor/tracker can incorporate gesture recognition, facial recognition and/or voice recognition.

The computer system (100) optionally includes a game controller input (144), which accepts control signals from one or more game controllers, over a wired connection or wireless connection. The control signals can indicate user inputs from one or more directional pads, buttons, triggers and/or one or more joysticks of a game controller. The control signals can also indicate user inputs from a touchpad or touchscreen, gyroscope, accelerometer, angular rate sensor, magnetometer and/or other control or meter of a game controller.

The computer system (100) optionally includes a media player (146) and video source (148). The media player (146) can play DVDs, Blu-ray™ discs, other disc media and/or other formats of media. The video source (148) can be a camera input that accepts video input in analog or digital form from a video camera, which captures natural video. Or, the video source (148) can be a screen capture module (e.g., a driver of an operating system, or software that interfaces with an operating system) that provides screen capture content as input. Or, the video source (148) can be a graphics engine that provides texture data for graphics in a computer-represented environment. Or, the video source (148) can be a video card, TV tuner card, or other video input that accepts input video in analog or digital form (e.g., from a cable input, high definition multimedia interface (“HDMI”) input or other input).

An optional audio source (150) accepts audio input in analog or digital form from a microphone, which captures audio, or other audio input.

The computer system (100) optionally includes a video output (160), which provides video output to a display device. The video output (160) can be an HDMI output or other type of output. An optional audio output (160) provides audio output to one or more speakers.

The storage (170) may be removable or non-removable, and includes magnetic media (such as magnetic disks, magnetic tapes or cassettes), optical disk media and/or any other media which can be used to store information and which can be accessed within the computer system (100). The storage (170) stores instructions for the software (180) implementing aspects of the innovations for sampling operations in a computer vision tool to regulate downstream tasks.

The computer system (100) may have additional features. For example, the computer system (100) includes one or more other input devices and/or one or more other output devices. The other input device(s) may be a touch input device such as a keyboard, mouse, pen, or trackball, a scanning device, or another device that provides input to the computer system (100). The other output device(s) may be a printer, CD-writer, or another device that provides output from the computer system (100).

An interconnection mechanism (not shown) such as a bus, controller, or network interconnects the components of the computer system (100). Typically, operating system software (not shown) provides an operating environment for other software executing in the computer system (100), and coordinates activities of the components of the computer system (100).

The computer system (100) of FIG. 1 is a physical computer system. A virtual machine can include components organized as shown in FIG. 1.

The term “application” or “program” refers to software such as any user-mode instructions to provide functionality. The software of the application (or program) can further include instructions for an operating system and/or device drivers. The software can be stored in associated memory. The software may be, for example, firmware. While it is contemplated that an appropriately programmed general-purpose computer or computing device may be used to execute such software, it is also contemplated that hard-wired circuitry or custom hardware (e.g., an ASIC) may be used in place of, or in combination with, software instructions. Thus, examples described herein are not limited to any specific combination of hardware and software.

The term “computer-readable medium” refers to any medium that participates in providing data (e.g., instructions) that may be read by a processor and accessed within a computing environment. A computer-readable medium may take many forms, including non-volatile media and volatile media. Non-volatile media include, for example, optical or magnetic disks and other persistent memory. Volatile media include dynamic random access memory (“DRAM”). Common forms of computer-readable media include, for example, a solid state drive, a flash drive, a hard disk, any other magnetic medium, a CD-ROM, DVD, any other optical medium, RAM, programmable read-only memory (“PROM”), erasable programmable read-only memory (“EPROM”), a USB memory stick, any other memory chip or cartridge, or any other medium from which a computer can read. The term “non-transitory computer-readable media” specifically excludes transitory propagating signals, carrier waves, and wave forms or other intangible or transitory media that may nevertheless be readable by a computer. The term “carrier wave” may refer to an electromagnetic wave modulated in amplitude or frequency to convey a signal.

The innovations can be described in the general context of computer-executable instructions being executed in a computer system on a target real or virtual processor. The computer-executable instructions can include instructions executable on processing cores of a general-purpose processor to provide functionality described herein, instructions executable to control a GPU or special-purpose hardware to provide functionality described herein, instructions executable on processing cores of a GPU to provide functionality described herein, and/or instructions executable on processing cores of a special-purpose processor to provide functionality described herein. In some implementations, computer-executable instructions can be organized in program modules. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or device. In general, a computer system or device can be local or distributed, and can include any combination of special-purpose hardware and/or hardware with software implementing the functionality described herein.

Numerous examples are described in this disclosure, and are presented for illustrative purposes only. The described examples are not, and are not intended to be, limiting in any sense. The presently disclosed innovations are widely applicable to numerous contexts, as is readily apparent from the disclosure. One of ordinary skill in the art will recognize that the disclosed innovations may be practiced with various modifications and alterations, such as structural, logical, software, and electrical modifications. Although particular features of the disclosed innovations may be described with reference to one or more particular examples, it should be understood that such features are not limited to usage in the one or more particular examples with reference to which they are described, unless expressly specified otherwise. The present disclosure is neither a literal description of all examples nor a listing of features of the invention that must be present in all examples.

When an ordinal number (such as “first,” “second,” “third” and so on) is used as an adjective before a term, that ordinal number is used (unless expressly specified otherwise) merely to indicate a particular feature, such as to distinguish that particular feature from another feature that is described by the same term or by a similar term. The mere usage of the ordinal numbers “first,” “second,” “third,” and so on does not indicate any physical order or location, any ordering in time, or any ranking in importance, quality, or otherwise. In addition, the mere usage of ordinal numbers does not define a numerical limit to the features identified with the ordinal numbers.

When introducing elements, the articles “a,” “an,” “the,” and “said” are intended to mean that there are one or more of the elements. The terms “comprising,” “including,” and “having” are intended to be inclusive and mean that there may be additional elements other than the listed elements.

When a single device, component, module, or structure is described, multiple devices, components, modules, or structures (whether or not they cooperate) may instead be used in place of the single device, component, module, or structure. Functionality that is described as being possessed by a single device may instead be possessed by multiple devices, whether or not they cooperate. Similarly, where multiple devices, components, modules, or structures are described herein, whether or not they cooperate, a single device, component, module, or structure may instead be used in place of the multiple devices, components, modules, or structures. Functionality that is described as being possessed by multiple devices may instead be possessed by a single device. In general, a computer system or device can be local or distributed, and can include any combination of special-purpose hardware and/or hardware with software implementing the functionality described herein.

Further, the techniques and tools described herein are not limited to the specific examples described herein. Rather, the respective techniques and tools may be utilized independently and separately from other techniques and tools described herein.

Device, components, modules, or structures that are in communication with each other need not be in continuous communication with each other, unless expressly specified otherwise. On the contrary, such devices, components, modules, or structures need only transmit to each other as necessary or desirable, and may actually refrain from exchanging data most of the time. For example, a device in communication with another device via the Internet might not transmit data to the other device for weeks at a time. In addition, devices, components, modules, or structures that are in communication with each other may communicate directly or indirectly through one or more intermediaries.

As used herein, the term “send” denotes any way of conveying information from one device, component, module, or structure to another device, component, module, or structure. The term “receive” denotes any way of getting information at one device, component, module, or structure from another device, component, module, or structure. The devices, components, modules, or structures can be part of the same computer system or different computer systems. Information can be passed by value (e.g., as a parameter of a message or function call) or passed by reference (e.g., in a buffer). Depending on context, information can be communicated directly or be conveyed through one or more intermediate devices, components, modules, or structures. As used herein, the term “connected” denotes an operable communication link between devices, components, modules, or structures, which can be part of the same computer system or different computer systems. The operable communication link can be a wired or wireless network connection, which can be direct or pass through one or more intermediaries (e.g., of a network).

A description of an example with several features does not imply that all or even any of such features are required. On the contrary, a variety of optional features are described to illustrate the wide variety of possible examples of the innovations described herein. Unless otherwise specified explicitly, no feature is essential or required.

Further, although process steps and stages may be described in a sequential order, such processes may be configured to work in different orders. Description of a specific sequence or order does not necessarily indicate a requirement that the steps or stages be performed in that order. Steps or stages may be performed in any order practical. Further, some steps or stages may be performed simultaneously despite being described or implied as occurring non-simultaneously. Description of a process as including multiple steps or stages does not imply that all, or even any, of the steps or stages are essential or required. Various other examples may omit some or all of the described steps or stages. Unless otherwise specified explicitly, no step or stage is essential or required. Similarly, although a product may be described as including multiple aspects, qualities, or characteristics, that does not mean that all of them are essential or required. Various other examples may omit some or all of the aspects, qualities, or characteristics.

An enumerated list of items does not imply that any or all of the items are mutually exclusive, unless expressly specified otherwise. Likewise, an enumerated list of items does not imply that any or all of the items are comprehensive of any category, unless expressly specified otherwise.

For the sake of presentation, the detailed description uses terms like “determine” and “select” to describe computer operations in a computer system. These terms denote operations performed by one or more processors or other components in the computer system, and should not be confused with acts performed by a human being. The actual computer operations corresponding to these terms vary depending on implementation.

### II. Sampling Operations in a Computer Vision Tool to Regulate Downstream Tasks

Media companies often have vast video archives including movies, television programs, user-provided video clips, and/or other types of video content. Advertising companies usually retain video content that they have generated, and security companies may have archives storing security footage. Aside from businesses, individual users may keep hundreds or thousands of hours of video footage that they have generated. Typically, video content is unstructured and difficult to search. Any of these entities may struggle to organize their video content and find relevant portions within their video content. Labels or other metadata can be added to files, or even to individual frames or segments of frames within a file, but the process of manually tagging video content is expensive and not scalable.

Computer vision tools can be used to add labels or other metadata to video content at the level of individual frames, segments of frames, or files. Computer-aided approaches can be scalable, consistent, and precise, but they may also be very expensive, especially when applied to a large video archive. In a conventional approach, a video sequence is completely decoded to reconstruct frames of the video sequence. Depending on the size of the video sequence, this can consume significant computational resources and memory. When multiple video sequences are decoded, resource utilization is even higher. After decoding, depending on the computer vision tool, downstream tasks may be run to perform video segmentation, object detection or recognition, object tracking, labeling of objects, action recognition, and/or another type of processing. Typically, a given task is adapted for a specific type of action or object (e.g., faces, persons, text or other characters, vehicles). As such, multiple versions of the same general type of task (e.g., object detection or recognition) may be run for different types of actions or objects. Individually, the tasks in a computer vision tool can consume significant computational resources and memory. Collectively, for a computer vision tool that attempts to detect, track, and label a wide variety of actions and objects, the cost can be prohibitive.

This section describes innovations in sampling operations in a computer vision tool to regulate downstream tasks. For a given downstream task such as action recognition, face detection or recognition, person tracking, or text or character recognition, not all frames of a video sequence benefit from processing with the given downstream task. The sampling operations provide a “sniffing” mechanism to categorize frames. Using results of the sampling operations, a computer vision tool can selectively perform or skip downstream tasks for different frames of a video sequence, so that only a subset of the downstream tasks is run for any given frame, or otherwise adjust how and when downstream tasks are performed for the different frames of the video sequence. Collectively, by avoiding performance of downstream tasks that are unlikely to produce useful results, the sampling operations can significantly reduce overall processor utilization and memory utilization for the downstream tasks.

For example, a computer vision tool receives encoded data for a given frame and uses the encoded data to determine inputs for machine learning models in different channels. Examples of inputs are described below. In some example implementations, the inputs are determined in a “lightweight” way decoding only a subset of frames (less than all of the frames) of a video sequence, which can reduce delay and overhead in the computer vision tool.

The computer vision tool provides the inputs to the machine learning models, respectively. Examples of machine learning models are described below. The computer vision tool fuses results from the machine learning models. In this way, the computer vision tool determines a set of one or more event indicators for the given frame. The event indicators can be scores for different event types, which indicate the likelihood of the given frame including events of the respective event types. Based at least in part on the event indicator(s) for the given frame, the computer vision tool regulates downstream tasks for the given frame. Appropriate downstream tasks for the given frame can be run after all frames of a video sequence have been analyzed in the sampling operations, or appropriate downstream tasks can run while subsequent frames are analyzed in the sampling operations. Some or all of the downstream tasks can be “local” to the computer vision tool that performs the sampling operations, or some or all of the downstream tasks can be distributed across a network.

### A. Example Computer Vision Tools

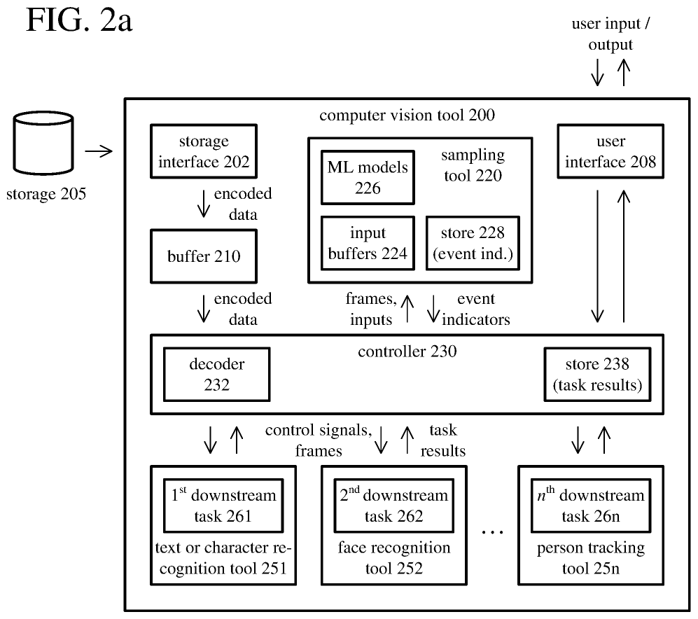

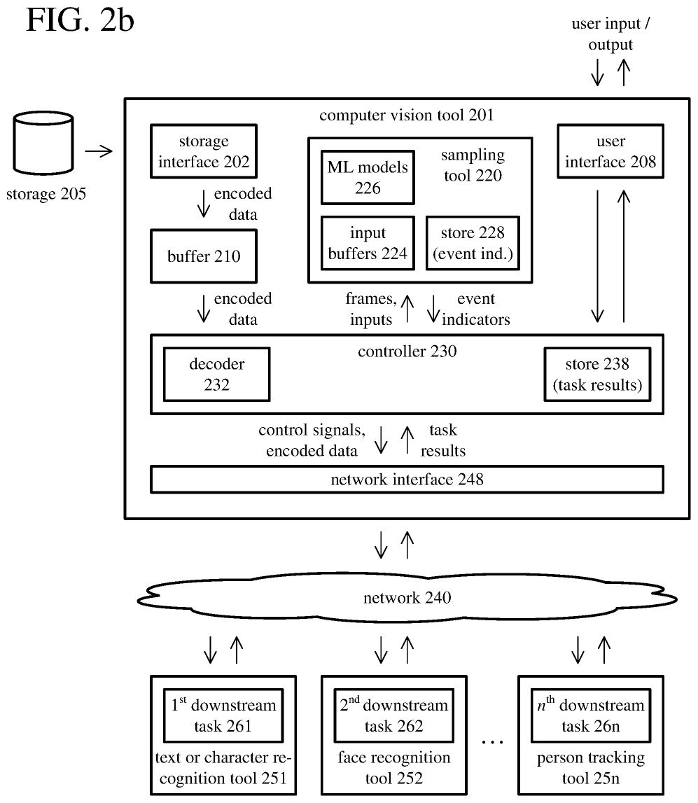

FIG. 2a shows an example computer vision tool (200) that performs sampling operations to regulate downstream tasks. The computer vision tool (200) includes a buffer (210), a sampling tool (220), a controller (230), and downstream tools (251 . . . 25n) that implement downstream tasks (261 . . . 26n).

Through the storage interface (202), the computer vision tool (200) retrieves encoded data for video content from storage (205). For example, the storage (205) is magnetic media (such as magnetic disks, magnetic tapes, or cassettes), optical disk media and/or other storage or memory media. Alternatively, the storage (205) can be another digital video source. The storage (205) can be, as described with reference to FIG. 1, storage (170) that stores video content, a media player (146) that produces video content from media, or another source that provides encoded data for video content. The buffer (210) stores the encoded data and provides the encoded data to the controller (230).

The controller (230) manages operations of the computer vision tool (200). The controller includes a video decoder (230). The controller (230) retrieves encoded data from the buffer (210) and decodes at least some of the encoded data using the video decoder (232) to reconstruct frames. For example, the video decoder (232) is an H.264/AVC decoder, H.265/HEVC decoder, VPx decoder, AV1 decoder, or decoder for another video codec standard or format. The controller (230) can also derive other inputs for machine learning models from the encoded data, such as motion information and/or residual information, as described in section II.B. Alternatively, the inputs for machine learning models are another type of inputs.

The sampling tool (220) performs sampling operations in order to provide information for the computer vision tool (200) to use when regulating downstream tasks (261 . . . 26n). For example, the sampling tool (220) performs operations as described in sections II.B and II.C. The sampling tool (220) includes input buffers (224), machine learning models (226), and a store (228) for event indicators.

From the controller (230), the sampling tool (220) receives frames and/or other inputs, which are inputs to the machine learning models (226). The input buffers (224) store the inputs. For example, the inputs are inputs in time series, as described in section II.B. Alternatively, the inputs are another type of inputs. Although FIG. 2a shows the sampling tool (220) receiving the frames and/or other inputs from the controller (230), which determines the inputs using encoded data, alternatively the sampling tool (220) itself determines the inputs. For example, the sampling tool (220) can retrieve encoded data from the buffer (210), decode at least some of the encoded data using a video decoder to reconstruct frames, and derive other inputs from the encoded data.

In the sampling tool (220), the machine learning models (226) process the inputs. The machine learning models (226) can be two-dimensional (“2D”) convolutional neural networks (“CNNs”), three-dimensional (“3D”) CNNs, video transformers, temporal dilated video transformers, or another type of machine learning model. Region of interest (“Rol”) bounding box regression can be used in combination with a CNN approach. Sections II.B and II.C describes examples of machine learning models.

The sampling tool (220) processes results from the machine learning models (226) to determine event indicators for the frames of a video sequence. Section II.B describes examples of event indicators. The sampling tool (220) stores the event indicators in the store (228) and provides the event indicators to the controller (230), which can use the event indicators to regulate the downstream tasks (261 . . . 26n). For example, the sampling tool (220) provides the event indicators in a file (such as a JSON file), which may be organized by frame (or timestamp) and event types.

The controller (230) receives the event indicators from the sampling tool (220) and uses the event indicators to regulate downstream tasks (261 . . . 26n). For example, the controller (230) selects which of the downstream tasks (261 . . . 26n) to run for the respective frames of a video sequence, determining whether a given downstream task should be performed or skipped for a given frame. Or, for a given frame, the controller (230) determines which operations of a given downstream task should be performed and which operations of the given downstream task should be skipped. The controller (230) determines control signals such as function calls to start downstream tasks (261 . . . 26n), parameters to provide to downstream tasks (261 . . . 26n), etc. In this way, the controller (230) specifies which downstream tasks (261 . . . 26n) or operations of tasks to perform. The controller (230) conveys the control signals to the respective downstream tools (251 . . . 25n), e.g., selectively making function calls, sending parameters, etc. For a given frame, the controller (230) can provide the given frame to selected ones of the downstream tools (251 . . . 25n) for processing by those of the downstream tasks (261 . . . 26n) that are run for the given frame. Alternatively, instead of providing a reconstructed version of the given frame, the controller (230) provides encoded data usable to reconstruct the given frame to appropriate ones of the downstream tasks (251 . . . 25n).

The downstream tools (251 . . . 25n) implement downstream tasks (261 . . . 26n). FIG. 2a shows a text or character recognition tool (251) that implements a 1^{st} downstream task (261), a face recognition tool (252) that implements a 2^{nd} downstream task (262), and a person tracking tool (26n) that implements an n^{th} downstream task. The downstream tools (251 . . . 25n) and downstream tasks (261 . . . 26n) shown in FIG. 2a are representative. In practice, the computer vision tool (200) can include more or fewer downstream tools and downstream tasks. A given downstream tool can implement a single downstream task or multiple downstream tasks.

For example, a downstream task can include operations for object detection or recognition for persons, faces, vehicles, logos (textual or symbolic), text or other characters, or another arbitrary type of object. Or, as another example, a downstream task can include operations for object tracking for persons, faces, vehicles, logos (textual or symbolic), text or other characters, or another arbitrary type of object. Or, as another example, a downstream task can include operations for action recognition for a particular type of action. For a “bring your own model” approach, one or more downstream tasks used in the computer vision tool (200) can be provided by a user or third party for an arbitrary type of object or action. In this way, the computer vision tool (200) can flexibly support changing requirements for downstream tasks. In general, for a specific type of object or action, a downstream task uses a model trained for that type of object or action.

The controller (230) receives results of the downstream tasks (261 . . . 26n). The task results can be, for example, events such as detected objects/actions or tracked objects in a frame or multiple frames. The controller (230) includes a store (238), which stores the results of the downstream tasks (261 . . . 26n). Through the user interface (208), task results can be presented as output. The controller (230) can also organize and store task results in a file (such as a JSON file), which may be organized by frame (or timestamp) and event types.

User input for the computer vision tool (200) can also be received through the user interface (208). In some example implementations, a user can specify one or more system resource constraints to limit downstream tasks. For example, a system resource constraint can indicate a maximum level of memory utilization, a minimum level of memory utilization, a maximum level of processor utilization, a minimum level of processor utilization, a maximum delay, or a minimum delay associated with downstream tasks, collectively or individually. When regulating the downstream tasks (261 . . . 26n), the controller (230) can also consider one or more ranges defined by system resource constraint(s) provided by the user or otherwise set for the computer vision tool (200).

The computer vision tool (200) can be implemented using various types of computer software and hardware. For example, the computer vision tool (200) can be implemented in cloud environment or in a “local” (on-premises) device (e.g., on-premises server computer, home personal computer). In some scenarios, a large video archive is stored at the same location as a computer system that implements a computer vision tool (200) with sampling operations. Moving the large video archive to a cloud environment for analysis operations may be prohibitively expensive. By using the sampling operations to regulate downstream tasks, the computer vision tool (200) can effectively perform analysis operations on the large video archive on premises.

In some example implementations, the computer vision tool (200) is implemented using software executable on one or more CPUs. Alternatively, at least some operations of the computer vision tool (200) (such as operations involving machine learning models) are implemented using software executable on one or more GPUs. The software can be stored in one or more non-transitory computer-readable media.

FIG. 2b shows another example computer vision tool (201) that performs sampling operations to regulate downstream tasks. In most respects, the computer vision tool of FIG. 2b is the same as the computer vision tool (200) of FIG. 2a. Unlike the computer vision tool (200) of FIG. 2a, however, the computer vision tool (201) of FIG. 2b does not include the downstream tools (251 . . . 25n) that implement downstream tasks (261 . . . 26n). Instead, the computer vision tool (201) connects to the downstream tools (251 . . . 25n) over a network (240) such as the Internet. Through a network interface (248), the controller (230) selectively provides control signals to the downstream tools (251 . . . 25n), so as to regulate the downstream tasks (261 . . . 26n). The control signals can be, for example, remote procedure calls to start downstream tasks (261 . . . 26n), parameters to provide to downstream tasks (261 . . . 26n), etc. For a given frame, the controller (230) provides encoded data usable to reconstruct the given frame to selected ones of the downstream tools (251 . . . 25n) for processing by those of the downstream tasks (261 . . . 26n) that are run for the given frame. Through the network interface (248), the controller (230) receives task results from the downstream tasks (261 . . . 26n).

The computer vision tool (201) can be implemented using various types of computer software and hardware. For example, the computer vision tool (201) can be implemented in cloud environment or in a “local” (on-premises) device (e.g., on-premises server computer, home personal computer). In some scenarios, a large video archive is stored at the same location as a computer system that implements a computer vision tool (201) with sampling operations. Moving the large video archive to a cloud environment for analysis operations may be prohibitively expensive. By using the sampling operations to regulate downstream tasks, the computer vision tool (201) can selectively send encoded data for frames of video content to downstream tools (251 . . . 25n) and selectively run downstream tasks (261 . . . 26n), controlling overall cost.

### B. Example Processing Flows

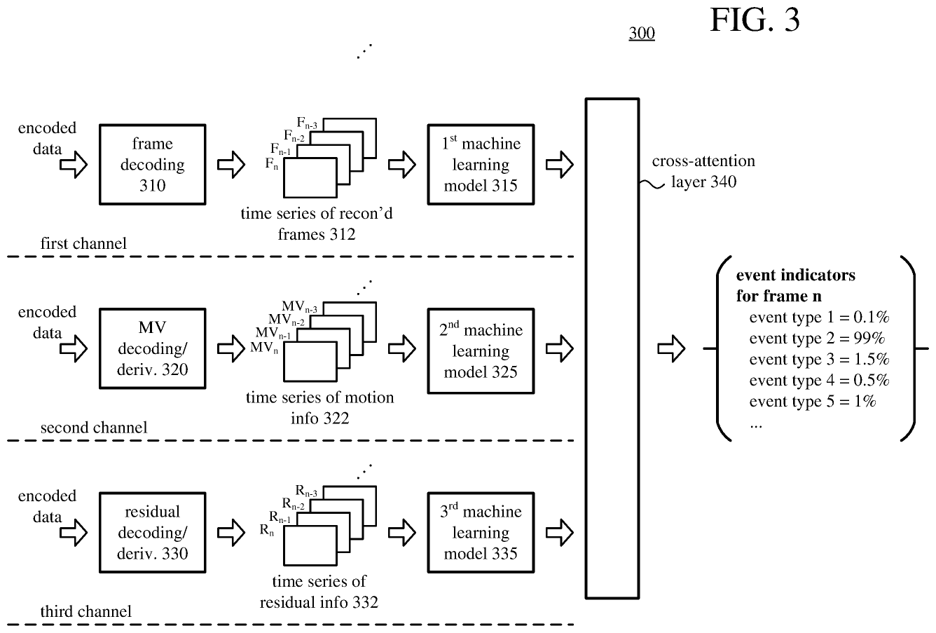

FIG. 3 shows an example processing flow (300) for sampling operations to regulate downstream tasks. The example processing flow (300) shows operations performed in a computer system that implements a computer vision tool, as described with reference to FIGS. 1, 2a, 2b, or otherwise. The operations for the example processing flow (300) can be implemented, for example, in a controller (230) and sampling tool (220) as described with reference to FIG. 2a or FIG. 2b.

The example processing flow (300) uses inputs decoded or derived from encoded data, including reconstructed versions of at least some frames of a video sequence, motion information for at least some frames of the video sequence, and residual information for at least some frames of the video sequence. Machine learning models (315, 325, 335) in the example processing flow (300) process the inputs using deep learning models for binary dense classification, and the results of the machine learning models (315, 325, 335) are processed by a cross-attention layer (340), providing classification results at frame level or some other temporal level. For a given frame, the output of the example processing flow (300) can be a set of event indicators for the given frame, where the set of event indicators for the given frame includes at least one event indicator. The event indicators generally indicate the relevance of different downstream tasks (associated with different event types) for the given frame. Frame-level visual insights can be aggregated to a different temporal resolution.

In some example implementations, encoded data is only partially decoded for the example processing flow (300). In this way, the example processing flow (300) can reduce the operational cost for decoding encoded video (compared to completely decoding video) and also limit operations of downstream tasks.

The example processing flow (300) includes three channels with different machine learning models (315, 325, 335). Alternatively, a processing flow includes more or fewer channels for different types of inputs.

With reference to FIG. 3, in the first channel, frame decoding operations (310) are performed on encoded data, producing a time series of reconstructed frames (312). In FIG. 3, the time series of reconstructed frames (312) includes frames Fₙ, Fₙ₋₁, Fₙ₋₂, Fₙ₋₃, etc. for times n, n-1, n-2, n-3, etc. For a frame having width w and height h, each reconstructed frame is organized as an arrangement of w×h sample values. In some example implementations, only intra-coded frames are decoded. An intra-coded frame has only intra-coded content (e.g., only I slices). For a frame that is not intra-coded, the previous intra-coded frame in display order is used in place of the non-intra-coded frame. Thus, when an intra-coded frame defines the start of a group of pictures (“GOP”), the reconstructed version of the intra-coded frame is used for every frame in the GOP.

For a given frame, the machine learning model (315) in the first channel accepts as input one of the reconstructed frames (312). The machine learning model (315) is trained to detect events in sample values of a reconstructed frame. The machine learning model (315) can be a 2D CNN, 3D CNN, video transformer, temporal dilated video transformer, or other machine learning model. Rol bounding box regression can be used in combination with a CNN approach. Section II.C describes examples of video transformers and temporal dilated video transformers, which can be used to implement the machine learning model (315). The machine learning model (315) in the first channel provides output to the cross-attention layer (340).

In the second channel, motion vector decoding and derivation operations (320) are performed on encoded data, producing a time series of motion information (322). In FIG. 3, the time series of motion information (322) includes motion fields MVₙ, MVₙ₋₁, MVₙ₋₂, MVₙ₋₃, etc. for times n, n-1, n-2, n-3, etc. For d×d blocks of a frame having width w and height h, a motion field is organized as an arrangement of w/d×h/d motion vectors, where the block size d is, e.g., 4, 8, or some other value. Alternatively, each motion field is organized as an arrangement of w×h motion vectors for sample value locations of the frame.

For a frame that is not intra-coded (e.g., has at least one P slice or B slice), motion vectors are decoded (e.g., using entropy decoding and/or motion vector prediction operations) or derived. Motion vectors that are explicitly signaled in the encoded data are decoded. Other motion vectors can be derived according to predicted motion for blocks or global motion for a frame or region of a frame, as indicated by information in the encoded data. For an intra-coded frame or for an intra-coded region in a non-intra-coded frame, zero-value motion vectors can be used.

Alternatively, without decoding of motion information using encoded data, motion information for a given frame can be determined by motion estimation relative to the previous frame in display order. The motion estimation can be block-based motion estimation, global motion estimation, or some other type of motion estimation. The motion estimation can produce a motion field of motion vectors for blocks or for individual sample locations of the given frame.

For a given frame, the machine learning model (325) in the second channel accepts as input one of the motion fields in the time series of motion information (322). The machine learning model (325) is trained to detect events in motion information. The machine learning model (325) can be a 2D CNN, 3D CNN, video transformer, temporal dilated video transformer, or other machine learning model. Rol bounding box regression can be used in combination with a CNN approach. Section II.C describes examples of video transformers and temporal dilated video transformers, which can be used to implement the machine learning model (325). The machine learning model (325) in the second channel provides output to the cross-attention layer (340).

In the third channel, residual decoding and derivation operations (330) are performed on encoded data, producing a time series of residual information (332). In FIG. 3, the time series of residual information (332) includes residual values Rₙ, Rₙ₋₁, Rₙ₋₂, Rₙ₋₃, etc. for times n, n-1, n-2, n-3, etc. For a frame having width w and height h, residual information is organized as an arrangement of w×h residual values.

In general, the residual values indicate differences between original sample values and corresponding motion-predicted values at the same locations. For a frame that is not intra-coded (e.g., has at least one P slice or B slice), residual values are decoded (e.g., using entropy decoding, inverse quantization, and inverse transform operations). For an intra-coded frame or for an intra-coded region in a non-intra-coded frame, zero-value residual values can be used. Alternatively, without decoding of residual values, residual values for a given frame can be determined as differences between the original sample values of the given frame and corresponding motion-predicted values at the same locations.

For a given frame, the machine learning model (335) in the third channel accepts as input one of the frames of residual values in the time series of residual information (332). The machine learning model (335) is trained to detect events in residual information. The machine learning model (335) can be a 2D CNN, 3D CNN, video transformer, temporal dilated video transformer, or other machine learning model. Rol bounding box regression can be used in combination with a CNN approach. Section II.C describes examples of video transformers and temporal dilated video transformers, which can be used to implement the machine learning model (335). The machine learning model (335) in the third channel provides output to the cross-attention layer (340).

In some example implementations, a machine learning model (315, 325, 335) is trained for a particular video codec standard or format. The machine learning model is trained using inputs produced from encoded data in the particular codec standard/format (in a training data set with labels for events). For a different codec standard/format, a machine learning model can be trained using inputs produced from encoded data in the different codec standard/format, which may be generated from the original video or may be generated through transcoding operations while retaining the labels for events for the training data set.

In the example processing flow (300) of FIG. 3, the cross-attention layer (340) fuses results from the machine learning models (315, 325, 335) in the different channels, which can improve precision by using shared spatial information from the different channels. As used herein, a cross-attention layer is any mechanism that aggregates results from machine learning models that process diverse inputs, which can be different types or modalities of inputs or inputs from different sources. For example, a cross-attention layer can determine weights (sometimes called attention weights) for different elements of input, then compute a weighted sum of the respective values of the input. The weighted sum represents a selective aggregation of the values of the input, based on the attention weights. For additional details about implementation options for the cross-attention layer, see, e.g., Vaswani et al., “Attention Is All You Need,” arXiv: 1706.03762v5, 15 pp. (2017); Chen et al., “Cross ViT” Cross-Attention Multi-Scale Vision Transformer for Image Classification,” arXiv: 2013.14899v2, 12 pp. (2021); or Kosar, “Cross-Attention in Transformer Architecture,” downloaded from the World Wide Web, 6 pp. (document marked 2022).

The cross-attention layer (340) outputs a set of event indicators for the given frame, where the set of event indicators for the given frame includes at least one event indicator. For example, an event indicator for the given frame is a single classification for the given frame, such as an object type (face, person, text or character, car, airplane, bicycle) or action type. Or, as shown in FIG. 3, event indicators for the given frame are scores for multiple types of events, such as different object types (face, person, text or character, car, airplane, bicycle) or different action types. In FIG. 3, a score is a percentage score between 0% (meaning it is extremely unlikely that the given frame includes an event of a particular event type) and 100% (meaning it is certain that the given frame includes an event of the particular event type). Alternatively, a score can be normalized between 0.0 (very unlikely) and 1.0 (certain), or follow another scale. Or, the event indicators can indicate a probability distribution over a set of event types for the given frame.

In the example process flow (300) of FIG. 3, machine learning models (315, 325, 335) in three different channels provide inputs to the cross-attention layer (340). Alternatively, a set of event indicators for a given frame can be determined using multi-modal analysis of encoded video according to another approach, for example, as described in Huo et al., “Compressed Video Contrastive Learning,” Advances in Neural Information Processing Systems, 34, 14176-14187 (2021); or Wu et al. “Compressed Video Action Recognition,” Proceedings IEEE Conference on Computer Vision and Pattern Recognition, pp. 6026-6035 (2018).

### C. Example Machine Learning Models

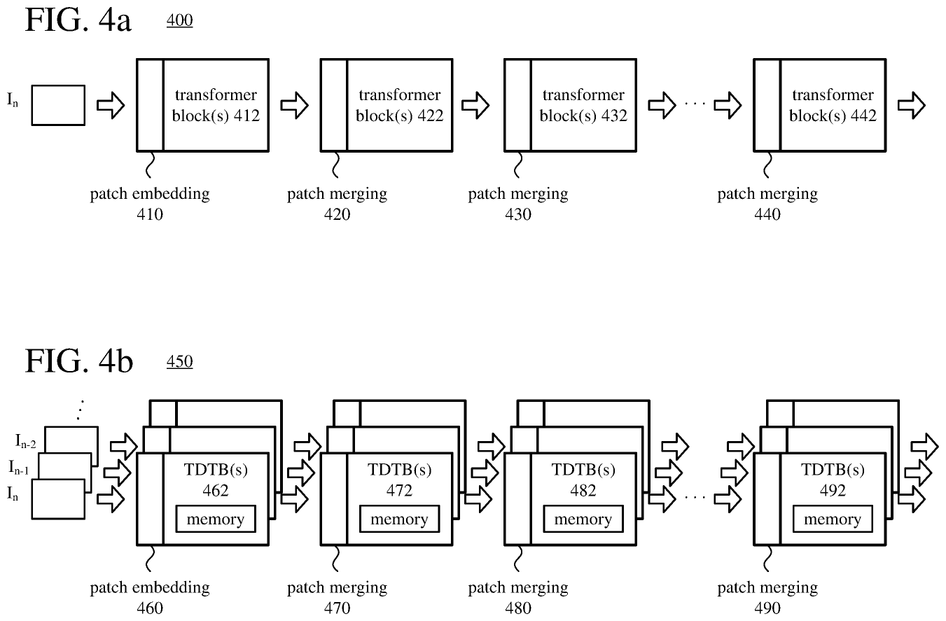

FIGS. 4a and 4b show example machine learning tools usable in sampling operations in a computer vision tool. Specifically, FIG. 4a shows a video transformer (400), and FIG. 4b shows a temporal dilated video transformer (450).

With reference to FIG. 4a, the video transformer (400) has multiple stages. The first stage of the video transformer (400) accepts input Iₙ. For example, the input Iₙ is a frame of sample values, a motion field, or a frame of residual values, as described with reference to FIG. 3. Alternatively, the input Iₙ is another type of input.

The first stage includes a patch embedding layer (410). The patch embedding layer (410) converts non-overlapping, two-dimensional sections (patches) of the input Iₙ into one-dimensional vectors that can be processed by the transform block(s) (412) of the first stage. Positions of the respective sections can be encoded in the one-dimensional vectors to provide relative spatial position information. The patch embedding layer (410) enables the video transformer (400) to extract features from specific regions of the input Iₙ. For example, the patch embedding layer has multiple layers of convolutional and pooling operations that extract features from the sections of the input Iₙ.

The first stage also includes a first set of one or more transformer blocks (412) after the patch embedding layer (410). Each of the transformer blocks (412) processes inputs to identify relationships and dependencies between different elements of the inputs. For example, each of the transformer block(s) (412) includes a multi-head attention mechanism followed by a multi-layer perceptron or other feed-forward neural network. The multi-head attention mechanism can apply multiple self-attention mechanisms in parallel to identify different types of dependencies and relationships between elements of the inputs of the transformer block. Attention weights can be computed to represent the importance of each element in the inputs relative to the others. The multi-layer perceptron or other feed-forward neural network can include multiple linear layers with a non-linear activation function between them. Inputs to the multi-head attention mechanism and feed-forward network can be normalized to improve stability. The outputs of the multi-head attention mechanism or feed-forward network can be added (as residuals) to the input for the sub-layer.

Each subsequent stage includes a patch merging layer (420, 430, 440) and a subsequent set of one or more transformer blocks (422, 432, 442). The patch merging layer (420, 430, 440) aggregates features extracted from sections (patches) of the input Iₙ into a single representation, for example, using a global average pooling layer (using the average of the features for each section) or max pooling layer (using the maximum of the features for each section). Each of the transformer block(s) (422, 432, 442) in the subsequent stages generally operates like one of the transformer block(s) (412) in the first stage.

The number of transformer blocks in each stage depends on implementation—by stacking transformer blocks, the video transformer (400) can determine a hierarchical representation of features in the input Iₙ. The first transformer block processes inputs from the patch embedding layer (410). Subsequent transformer blocks process inputs from a patch merging layer or preceding transformer block in the same stage. For example, the first stage includes two transformer blocks, and each subsequent stage includes two, six, or more transformer blocks.

Components of the video transformer (400) can operate as described in Dosovitskiy et al., “An Image Is Worth 16×16 Words: Transformers for Image Recognition at Scale, arXiv preprint arXiv: 2010.11929 (2020). Alternatively, the video transformer (400) can be implemented in a different way.

With reference to FIG. 4b, the temporal dilated video transformer (450) has multiple stages. The first stage of the temporal dilated video transformer (450) accepts input Iₙ. For example, the input Iₙ is a frame of sample values, motion field, or frame of residual values, as described with reference to FIG. 3. Alternatively, the input Iₙ is another type of input. The temporal dilated video transformer (450) fuses inputs along the temporal axis, which can make results less “jittery.” In practice, temporal dilation is implemented using memory structures in temporal dilated transformer blocks (“TDTBs”), which buffer and use (as inputs when also processing current inputs Iₙ) results from processing on previous inputs Iₙ₋₁, Iₙ₋₂, Iₙ₋₃, etc. In this way, information from past frames can be diffused to the current frame (and subsequent frames) in order to improve temporal coherency. For example, this can help detect the same object in consecutive frames.

The first stage of the temporal dilated video transformer (450) includes a patch embedding layer (460), which generally operates like the patch embedding layer (410) described with reference to FIG. 4a. The first stage of the temporal dilated video transformer (450) also includes a first set of one or more TDTBs (462) after the patch embedding layer (460). Each of the TDTBs (462) processes current inputs Iₙ, to identify relationships and dependencies between different elements of the current inputs Iₙ, but also includes a memory structure, which enables the TDTB to identify relationships and dependencies between elements of the current inputs Iₙ, and elements of the previous inputs Iₙ₋₁, Iₙ₋₂, Iₙ₋₃, etc. For example, each of the TDTB(s) (462) includes a memory structure and a multi-head attention mechanism, followed by a multi-layer perceptron or other feed-forward neural network.

The memory structure of the TDTB buffers results from processing of previous inputs by the TDTB. Following a temporal sampling strategy, the memory structure selectively provides buffered values as inputs when processing current inputs Iₙ. In successive stages of the temporal dilated video transformer (450), the temporal window across inputs can be successively widened.

The multi-head attention mechanism can apply multiple self-attention mechanisms in parallel to identify different types of dependencies and relationships between elements of the current inputs Iₙ of the TDTB and temporally sampled previous results. Attention weights can be computed to represent the importance of each element in the inputs relative to the others. The multi-layer perceptron or other feed-forward neural network can include multiple linear layers with a non-linear activation function between them. Inputs to the multi-head attention mechanism and feed-forward network can be normalized to improve stability. Also, the outputs of the multi-head attention mechanism or feed-forward network can be added (as residuals) to the input for the sub-layer. The results of the TDTB are stored in the memory structure of the TDTB, for use in subsequent operations of the TDTB.

Each subsequent stage of the temporal dilated video transformer (450) includes a patch merging layer (470, 480, 480) and a subsequent set of one or more TDTBs (472, 482, 492). The patch merging layers (470, 480, 480) generally operate like the patch merging layers (420, 430, 440) described with reference to FIG. 4a. Each of the TDTBs (472, 482, 492) in the subsequent stages generally operates like one of the TDTB(s) (462) in the first stage.

The number of TDTBs in each stage depends on implementation—by stacking TDTBs, the temporal dilated video transformer (450) can determine a hierarchical representation of features in the input. The first TDTB processes inputs from the patch embedding layer (460). Subsequent TDTBs process inputs from a patch merging layer or preceding TDTB in the same stage. For example, the first stage includes two TDTBs, and each subsequent stage includes two, six, or more TDTBs.

Components of the temporal dilated video transformer (450) can operate as described in Sun et al., “TDVIT: Temporal Dilated Video Transformer for Dense Video Tasks,” in Proceedings of Computer Vision-ECCV 2022, 17th European Conference, Tel Aviv, Israel, Oct. 23-27, 2022, pp. 285-301 (2022). Alternatively, the temporal dilated video transformer (450) can be implemented in a different way.

### D. Example Techniques for Sampling Operations to Regulate Downstream Tasks

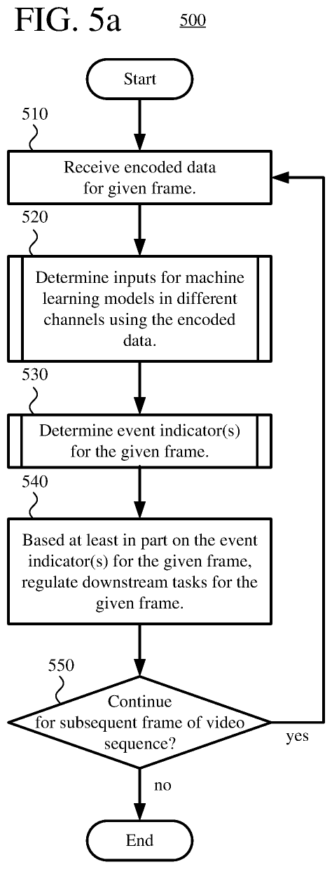

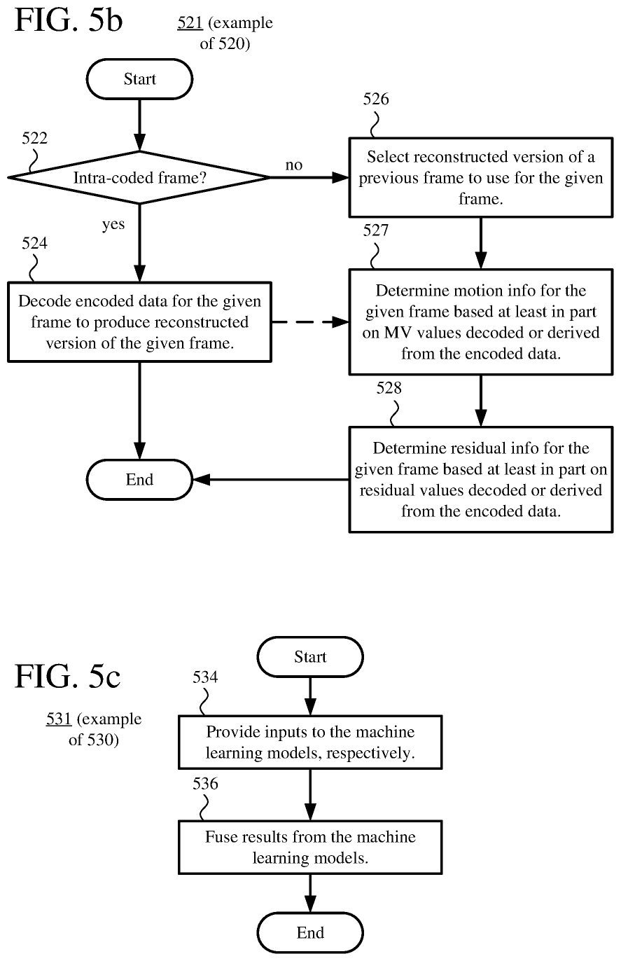

FIG. 5a shows a generalized technique (500) for sampling operations in a computer vision tool to regulate downstream tasks. A computer system that implements a computer vision tool, as described with reference to FIG. 1, 2a, or 2b or otherwise, can perform the technique (500). FIGS. 5b and 5c show example operations (521, 531) for two of the operations, respectively, in FIG. 5a.

To start, the computer vision tool receives (510) encoded data for a given frame of a video sequence. For example, the encoded data is in H.264/AVC format, H.265/HEVC format, VPx format, AV1 format, or another video codec format. In general, machine learning models used in the sampling operations have been trained using encoded data in a specific video codec format.

The computer vision tool determines (520) inputs for machine learning models in different channels using the encoded data. For example, the inputs for the given frame are part of different time series such as a time series of reconstructed frames, a time series of motion information, and a time series of residual information. In some example implementations, the time series of reconstructed frames includes reconstructed versions of intra-coded frames. Alternatively, the time series of reconstructed frames includes other and/or additional frames. Also, the inputs for the given frame can include inputs in fewer time series (e.g., just reconstructed frames and motion information) or additional time series.

In the example operations (521) of FIG. 5b, the computer vision tool determines (522) whether the given frame is intra-coded and selectively decodes encoded data for the given frame. If the given frame is intra-coded, the computer vision tool decodes (524) encoded data for the given frame to produce a reconstructed version of the given frame. The reconstructed version of the given frame is added as part of the time series of reconstructed frames. On the other hand, if the given frame is not intra-coded, the computer vision tool selects (526), from the time series of reconstructed frames, a reconstructed version of a previous frame to use for the given frame.

The computer vision tool also determines (527) motion information for the given frame based at least in part on motion vector values decoded or derived from the encoded data. In doing so, the computer vision tool can decode explicitly signaled motion vector values for at least some blocks of the given frame. The computer vision tool can derive motion vector values for other blocks of the given frame (e.g., skipped blocks with predicted motion or blocks with global motion). Blocks with no motion (e.g., blocks in an intra-coded region of a non-intra-coded frame) can be given zero-value motion vectors. The motion vectors can be assigned to uniform-size blocks for the given frame, e.g., 8×8 blocks or 4×4 blocks.

The computer vision tool also determines (528) residual information for the given frame based at least in part on residual values decoded or derived from the encoded data. In doing so, the computer vision tool can decode explicitly signaled residual values for at least some blocks of the given frame. Blocks with no residual information (e.g., blocks with exact motion-compensated prediction; intra-coded blocks that have no motion-predicted residuals) can be given zero-value residuals. The residual values can be assigned to the various locations of the given frame.

In this way, the computer vision tool can use the encoded data to determine the inputs while decoding only a subset of frames (less than all of the frames) of the video sequence, thereby reducing resource utilization to determine the inputs. (Blocks of an intra-coded frame can be assigned zero-value motion vectors and zero-value residuals, as indicated by the dashed line in FIG. 5b.)

Alternatively, the computer vision tool can determine the inputs using the encoded data in another way. For example, the computer vision tool can decode all frames of the video sequence. For each given frame after the first frame, the computer vision tool can determine motion information using block-based motion estimation, global motion estimation, or other motion estimation between the given frame and the previous frame, and calculate residual information as the differences between the sample values of the given frame and corresponding motion-predicted values. In this case, the motion information for the given frame is computed relative to the previous frame. Or, the computer vision system can use only intra-coded frames as inputs but determine motion information for a given frame relative to the previous intra-coded frame in the video sequence (aggregating motion information for intervening frames between the given frame and the previous intra-coded frame) and determine residual information as the differences between the sample values of the given frame and corresponding motion-predicted values.

With reference to FIG. 5a, the computer vision tool determines (530) a set of event indicators for the given frame. The set of event indicators for the given frame includes at least one event indicator. For example, an event indicator for the given frame is a single classification for the given frame, such as an object type or action type. In such an approach, different downstream tasks have been trained for different types of classifications, and the frame can be assigned to the appropriate downstream task given the classification for the given frame. Alternatively, event indicators for the given frame are scores for multiple types of events, such as different object types or different action types. A score can be a percentage score between 0% (meaning it is extremely unlikely that the given frame includes an event of a particular event type) and 100% (meaning it is certain that the given frame includes an event of the particular event type). Or, a score can be normalized between 0.0 (very unlikely) and 1.0 (certain), or follow another scale. In such an approach, different downstream tasks have been trained for different types of events, and the frame can be assigned to the appropriate downstream task or tasks given the event type scores for the given frame.

The computer vision tool can determine (530) the event indicator(s) for the given frame in various ways. In the example operations (531) of FIG. 5c, the computer vision tool provides (534) the inputs to the machine learning models, respectively, and fuses (536) results from the machine learning models. A machine learning model can use a 2D CNN or 3D CNN. Or, a machine learning model can use a video transformer, e.g., as described with reference to FIG. 4a. Or, a machine learning model can use a temporal dilated video transformer, e.g., as described with reference to FIG. 4b. Alternatively, a machine learning model can use a different approach. To fuse the results from the machine learning models, the computer vision tool can use a cross-attention layer or other approach to aggregate the results.

In some example implementations, the computer vision tool uses machine learning models in three different paths, e.g., as shown in FIG. 3. The computer vision tool provides first input for the given frame, from a time series of reconstructed frames, to a first machine learning model, which has been trained to identify events in reconstructed frames. The computer vision tool provides second input for the given frame, from a time series of motion information, to a second machine learning model, which has been trained to identify events in motion information. The computer vision tool provides third input for the given frame, from a time series of residual information, to a third machine learning model, which has been trained to identify events in residual information.

With reference to FIG. 5a, based at least in part on the event indicator(s) for the given frame, the computer vision tool regulates (540) downstream tasks for the given frame. For example, the computer vision tool selects which of the downstream tasks, if any, to use for the given frame. For each given downstream task among the downstream tasks, the computer vision tool can determine whether the given downstream task is to be used for the given frame and selectively perform the given downstream task for the given frame. If the given downstream task is to be used for the given frame, the computer vision tool performs the given downstream task for the given frame. On the other hand, if the given downstream task is not to be used for the given frame, the computer vision tool skips the given downstream task for the given frame. If the given downstream task is run on a separate computer system, the computer vision tool can cause the given downstream task to be performed or skipped for the given frame. Alternatively, the computer vision tool adjusts one or more of the downstream tasks for the given frame. In any case, by regulating the downstream tasks, the computer vision tool can reduce overall resource utilization by the downstream tasks.

In regulating the downstream tasks using the event indicators, the computer vision tool can perform various operations. For example, if an event indicator is a classification, the computer vision tool can select downstream task(s) appropriate for the classification. Alternatively, if an event indicator is a score, the computer vision tool can compare the score to a threshold associated with a downstream task. If the score is greater than the threshold, the downstream task is used; otherwise, the downstream task is not used.

The downstream tasks depend on implementation. In general, the downstream tasks follow the sampling operations. That is, the downstream tasks are “downstream” from the sampling operations in the processing flow of the computer vision tool. For example, the downstream tasks include a text or character recognition task, a face detection task, a person detection task, a vehicle detection task, an object detection task for another type of object, a face tracking task, a person tracking task, a vehicle tracking task, an object tracking task for another type of object, and/or an action recognition task for a type of action. Alternatively, the downstream tasks include other and/or additional tasks. Some or all of the downstream tasks can be performed by the computer vision tool that performs the sampling operations. Alternatively, some or all of the downstream tasks can be performed on a different computer system connected over a network to the computer system that implements the computer vision tool.

In general, one or more downstream tasks appropriate for a given frame can be performed after the sampling operations for the given frame. In some implementations, the sampling operations for all frames complete before any downstream tasks begin. That is, downstream task(s) appropriate for a given frame are performed after sampling operations have been performed for all frames of the video sequence. Alternatively, at least some of the downstream tasks for the given frame can be performed concurrently with sampling operations for a subsequent frame.

The computer vision tool can regulate downstream tasks based on additional factors. For example, the computer vision tool accepts, as user input, one or more system resource constraint indicators. In this case, the regulation of downstream tasks is also based at least in part on the system resource constraint indicator(s), e.g., so that downstream tasks operate within a range of acceptable resource utilization.

The computer vision tool can perform the sampling operations of FIG. 5a on a frame-by-frame basis. After performing the operations for the given frame, the computer vision tool can repeat the sampling operations for each of one or more subsequent frames as the given frame. For example, the computer vision tool can receive encoded data for a subsequent frame, use the encoded data to determine inputs for the subsequent frame for the machine learning models, determine event indicator(s) for the subsequent frame, and regulate downstream tasks for the subsequent frame. Alternatively, the computer vision tool can perform the sampling operations shown in FIG. 5a with a different timing. For example, the computer vision tool can receive encoded data for multiple frames and use the encoded data to determine inputs for the multiple frames before determining event indicators for the multiple frames. More generally, for a subsequent frame, the computer vision tool can perform the receiving, the using, the determining, and/or the regulating operations for the subsequent frame concurrent with performing the same operation(s) for the given frame.

### E. Technical Advantages

Integration of sampling operations into a computer vision tool provides various technical advantages, compared to approaches that lack sampling operations.

In terms of resource utilization by downstream tasks, integration of sampling operations into a computer vision tool can reduce overall process utilization and memory utilization by enabling the computer vision tool to select and run appropriate downstream tasks for a given frame. On the other hand, when other (inappropriate) downstream tasks are unlikely to produce useful results, such downstream tasks can be skipped, or operations within downstream tasks can be selectively eliminated. For example, if a given frame very likely includes a face but not text/characters or vehicles, a downstream task for face recognition can be run, while downstream tasks to detect text/characters or vehicles can be skipped. Thus, by using sampling operations to determine event indicators for frames and adjusting downstream tasks accordingly, overall utilization of resources in a computer system can be reduced.

In terms of accuracy of results of downstream tasks, integration of sampling operations into a computer vision tool can improve accuracy by screening which frames are provided to different downstream tasks. Downstream tasks are run on frames for which the downstream tasks are likely to produce useful results. This can avoid false positives (events identified by downstream tasks that are not actual events). If sampling operations are performed effectively, false negatives (events not identified by downstream tasks because those downstream tasks are skipped) are minimal.

In terms of bandwidth utilization in networked environments with distributed downstream tasks, integration of sampling operations into a computer vision tool can enable the computer vision tool to skip sending encoded data for some frames to some downstream tasks. Instead, the computer vision tool selectively sends encoded data for frames to appropriate downstream tasks.

In terms of flexibility and reusability, integration of sampling operations into a computer vision tool can enable the computer vision tool to support an extremely wide range of downstream tasks, covering a variety of object types and action types, for video content produced by diverse video sources (e.g., low-quality video feeds from a security camera; medium-quality video clips from a Web site; or high-quality video from a broadcast). New downstream tasks can be added in reaction to changing requirements. Even with a very large library of available downstream tasks, by selectively using targeted downstream tasks that are appropriate for a given frame, the computer vision tool can avoid the cost of evaluating all downstream tasks for each frame, without a significant penalty to the accuracy of the results of the downstream tasks.

In terms of resource utilization in sampling operations, partial decoding of frames can reduce memory utilization to store reconstructed frames and eliminate some computational-intensive decoding operations.

In terms of accuracy of sampling operations, using multi-modal inputs can improve accuracy of the sampling operations. For example, using motion information may improve the accuracy for tracking operations, and using residual information may improve the accuracy for edge detection for objects.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. In a computer system that implements a computer vision tool, a method of regulating downstream tasks, the method comprising:
receiving encoded data for a given frame of a video sequence;
determining inputs for machine learning models in different channels using the encoded data;
determining a set of event indicators for the given frame, including:
providing the inputs to the machine learning models, respectively; and
fusing results from the machine learning models; and
based at least in part on the set of event indicators for the given frame, regulating downstream tasks for the given frame.

2. The method of claim 1, wherein the inputs for the given frame are part of different time series that include:
a time series of reconstructed frames;
a time series of motion information; and
a time series of residual information.

3. The method of claim 2, wherein the determining the inputs includes:
determining whether the given frame is intra-coded;
selectively decoding encoded data for the given frame, including:
if the given frame is intra-coded, decoding encoded data for the given frame to produce a reconstructed version of the given frame, wherein the reconstructed version of the given frame is part of the time series of reconstructed frames; or
otherwise, the given frame not being intra-coded, selecting, from the time series of reconstructed frames, a reconstructed version of a previous frame to use for the given frame;
determining motion information for the given frame based at least in part on motion vector values decoded or derived from the encoded data; and
determining residual information for the given frame based at least in part on residual values decoded or derived from the encoded data.

4. The method of claim 2, wherein the providing the inputs to the machine learning models, respectively, includes:
providing first input, from the time series of reconstructed frames, to a first machine learning model among the machine learning models, the first machine learning model having been trained to identify events in reconstructed frames;
providing second input, from the time series of motion information, to a second machine learning model among the machine learning models, the second machine learning model having been trained to identify events in motion information; and
providing third input, from the time series of residual information, to a third machine learning model among the machine learning models, the third machine learning model having been trained to identify events in residual information.

5. The method of claim 1, wherein the determining the inputs is performed with decoding of less than all frames of the video sequence, thereby reducing resource utilization to determine the inputs.

6. The method of claim 1, wherein each of the machine learning models uses:
a two-dimensional convolutional neural network;
a three-dimensional convolutional neural network;
a video transformer; or
a temporal dilated video transformer.

7. The method of claim 1, wherein one of the machine learning models uses a temporal dilated video transformer, the temporal dilated video transformer comprising:
an initial stage, the initial stage having a patch embedding layer and an initial set of temporal dilated transformer blocks; and
a set of successive stages, each of the set of successive stages having a patch merging layer and a successive set of temporal dilated transformer blocks.

8. The method of claim 1, wherein the machine learning models have been trained using encoded data in a specific video codec format.

9. The method of claim 1, wherein the fusing the results from the machine learning models uses a cross-attention layer.

10. The method of claim 1, wherein the set of event indicators for the given frame are:
a single classification for the given frame, wherein different ones of the downstream tasks have been trained for different types of classification; or
a score for each of multiple types of events, wherein different ones of the downstream tasks have been trained for different types of events.

11. The method of claim 1, wherein the regulating the downstream tasks includes:
selecting which of the downstream tasks, if any, to use for the given frame; or
adjusting one or more of the downstream tasks for the given frame.

12. The method of claim 1, wherein the regulating the downstream tasks reduces overall resource utilization by the downstream tasks, and wherein the regulating the downstream tasks includes, for each given downstream task among the downstream tasks:
determining whether the given downstream task is to be used for the given frame; and
selectively performing the given downstream task for the given frame, including:
if the given downstream task is to be used for the given frame, performing the given downstream task for the given frame; or
otherwise, the given downstream task not being used for the given frame, skipping the given downstream task for the given frame.

13. The method of claim 1, further comprising:
accepting, as user input, a system resource constraint indicator, wherein the regulating the downstream tasks is also based at least in part on the system resource constraint indicator, whereby the downstream tasks operate within a range of acceptable resource utilization.

14. The method of claim 1, wherein the downstream tasks include a text or character recognition task, a face detection task, a person detection task, a vehicle detection task, an object detection task for another type of object, a face tracking task, a person tracking task, a vehicle tracking task, an object tracking task for another type of object, and/or an action recognition task for a type of action.

15. The method of claim 1, wherein the downstream tasks are performed on a different computer system connected over a network to the computer system that implements the computer vision tool.

16. The method of claim 1, further comprising:
for a subsequent frame of the video sequence, as the given frame, repeating the receiving, the using, the determining, and the regulating on a frame-by-frame basis; or
for the subsequent frame of the video sequence, performing the receiving, the using, the determining, and/or the regulating for the subsequent frame concurrent with the same operation or operations for the given frame.

17. A computer-readable medium having stored thereon computer-executable instructions for causing a processing system, when programmed thereby, to perform operations of a computer vision tool to regulate downstream tasks, the operations comprising:
receiving encoded data for a given frame of a video sequence;
determining inputs for machine learning models in different channels using the encoded data;
determining a set of event indicators for the given frame, including:
providing the inputs to the machine learning models, respectively; and
fusing results from the machine learning models; and
based at least in part on the set of event indicators for the given frame, regulating downstream tasks for the given frame.

18. A computer system comprising a processing system and memory, wherein the computer system implements a computer vision tool comprising:
a buffer, implemented using the memory of the computer system, configured to receive encoded data for a given frame of a video sequence; and
a sampling tool, implemented using the processing system of the computer system, configured to perform sampling operations comprising:
determining inputs for machine learning models in different channels using the encoded data; and
determining a set of event indicators for the given frame, including:
providing the inputs to the machine learning models, respectively; and
fusing results from the machine learning models; and
based at least in part on the set of event indicators for the given frame, regulating downstream tasks for the given frame.

19. The computer system of claim 18, further comprising:
downstream tools configured to perform operations for the downstream tasks, respectively.

20. The computer system of claim 18, wherein:
one of the machine learning models uses a temporal dilated video transformer, the temporal dilated video transformer comprising:
an initial stage, the initial stage having a patch embedding layer and an initial set of temporal dilated transformer blocks; and
a set of successive stages, each of the set of successive stages having a patch merging layer and a successive set of temporal dilated transformer blocks; and
the fusing the results from the machine learning models uses a cross-attention layer.
